(19) United States
(12) Patent Application Publication
(10) Pub. No.: US 2018/0015417 A1
(43) Pub. Date: Jan. 18, 2018

(54) CLEANING METHOD FOR WATER TREATMENT MEMBRANE

(71) Applicant: MITSUBISHI HEAVY INDUSTRIES, LTD., Tokyo (JP)

(72) Inventors: Shintaro Taura, Tokyo (JP); Masayuki Tabata, Tokyo (JP); Yoshiaki Ito, Tokyo (JP); Katsuhiko Yokohama, Tokyo (JP); Toshio Sao, Isahaya-shi (JP)

(73) Assignee: MITSUBISHI HEAVY INDUSTRIES, LTD., Tokyo (JP)

(21) Appl. No.: 15/545,866

(22) PCT Filed: Feb. 25, 2015
(86) PCT No.: PCT/JP2015/055470

§ 371 Date: Jul. 24, 2017

(51) Int. Cl. B01D 61/08; C02F 1/44

(52) U.S. Cl. CPC B01D 61/08; C02F 1/44; B01D 2311/12

(57) ABSTRACT

A cleaning method for a water treatment membrane (2) provided with a primary surface (2a) for inflow of untreated water and a secondary' surface (2b) for outflow of treated water, the method including a first cleaning step of bringing a first cleaning fluid containing a metal eluent into contact with at least the primary surface and eliminating metallic scale (11) attached to the water treatment membrane, and then a second cleaning step for bringing a second cleaning fluid containing an oxidizing agent into contact with at least the primary surface and eliminating organic scale (12) attached to the water treatment membrane.

### TECHNICAL FIELD

The present invention relates to a cleaning method for a water treatment membrane.

### BACKGROUND ART

In a seawater desalination device provided with a reverse osmotic membrane, seawater to be treated is first passed through the treatment device filled with a hollow fiber membrane or the like so that impurities such as solid matter are eliminated. The seawater treated with the treatment device is pressurized with a high-pressure pump and brought into contact with the reverse osmotic membrane so as to be separated into freshwater which passes through the reverse osmotic membrane and concentrated seawater which does not pass through the reverse osmotic membrane. The resulting freshwater is used for applications such as drinking water.

One cause of decreases in the permeability of a reverse osmotic membrane is clogging resulting from the attachment of scale including metal compounds such as iron and manganese as well as organic matter including microorganisms contained in the seawater and metabolic products thereof. A chemical cleaning line is typically installed in a seawater desalination device provided with a reverse osmotic membrane for the purpose of eliminating this clogging. When the amount of treated water of the reverse osmotic membrane or the hollow fiber membrane has reduced, the operation is stopped and chemical cleaning is performed using chemicals.

A known method for eliminating scale attached to a water treatment membrane such as a reverse osmotic membrane or a hollow fiber membrane includes a method of cleaning with a cleaning fluid containing a chemical such as hypochlorous acid, citric acid, or hydrogen peroxide. In addition to the chemicals described above, Patent Document 1 proposes a cleaning fluid containing percarbonate and an iron salt. Since percarbonate produces hydrogen peroxide in water, it reacts with the iron salt to yield an OH radical. An effect of oxidatively decomposing organic matter using this OH radical is described.

### CITATION LIST

### Patent Document

Patent Document 1: Japanese Patent No. 4384741B

### SUMMARY OF INVENTION

### Technical Problems

In order to avoid the oxidative degradation of a water treatment membrane, citric acid, which has a mild detergency, is often used for the purpose of cleaning scale. However, since the detergency of citric acid is low around room temperature, it is difficult to sufficiently eliminate metal compounds in the scale attached to a water treatment membrane with citric acid. In addition, organic matter such as insoluble polysaccharides insoluble in acid is contained in the scale attached to the water treatment membrane. It is therefore extremely difficult to sufficiently eliminate scale containing organic matter with citric, acid.

To eliminate organic matter in scale, the use of a potent oxidizer such as hypochlorous acid or hydrogen peroxide has also been proposed in the past. However, due to concerns regarding the oxidative degradation of the water treatment membrane, there are practically no cases in which this has been used on a practical level at an actual water treatment plant. The cleaning fluid containing sodium percarbonate proposed in Patent Document 1 produces hydrogen peroxide from sodium percarbonate, so the concern regarding the oxidative degradation of the water treatment membrane is not eliminated.

Scale attached to a water treatment membrane used in an actual water treatment plant contains not only organic matter, but also large quantities of metal compounds. Since these metal compounds function as a cracking catalyst for hydrogen peroxide, active oxygen having strong oxidative power is generated in large quantities, which induces the oxidative degradation of the water treatment membrane or diminishes the membrane performance.

As described above, conventional cleaning methods has a problem in that it is difficult, to select thee type of chemical to be contained in the cleaning fluid since there is a trade-off relationship between avoiding the oxidative degradation of the water treatment membrane and achieving the detergency required to eliminate the attached scale. In addition, there are also problems with conventional methods in which a cleaning fluid is brought into contact with the water treatment membrane.

Cleaning is performed with a circulation cleaning method, wherein a feeder line and an outlet line are connected to a vessel provided with a water treatment membrane on the inside thereof, and a cleaning fluid is continuously fed from the feeder line so that the circulating cleaning fluid is brought into contact with the water treatment membrane, after which the cleaning fluid is continuously discharged from the outlet line. With this method, the cleaning fluid easily flows to locally formed flow paths or channels which have little resistance due to a small amount of scale attachment, but it is difficult for the cleaning fluid to flow to sites where there is a large amount of scale attachment. Thus, the cleaning effect of sufficiently eliminating scale is difficult to achieve.

The present invention was conceived in order to solve the problems described above, and an object thereof is to provide a cleaning method for a water treatment membrane which yields a sufficient cleaning effect and is capable of suppressing the oxidative degradation of a water treatment membrane caused by active oxygen originating from an oxidizer.

### Solution to Problem

In order to solve the above-described problems, the present invention provides the following means.

A first aspect of the present invention is a cleaning method for a water treatment membrane provided with a primary surface for inflow of untreated water and a secondary surface for outflow of treated water, the method including: a first cleaning step of bringing a first cleaning fluid containing a metal eluent into contact with at least the primary surface and eliminating metallic scale attached to the water treatment membrane; and a second cleaning step of bringing a second cleaning fluid containing an oxidizing agent into contact with at least the primary surface and eliminating organic scale attached to the water treatment membrane.

With the cleaning method for a water treatment membrane according to the first aspect, most metal scale is eliminated by the first cleaning step, so there is no concern that a large amount of active oxygen originating from the oxidizer may be generated in the second cleaning step. As a result, it is possible to suppress the oxidative degradation of the water treatment membrane due to active oxygen and to achieve a sufficient cleaning effect.

A second aspect of the present invention is the cleaning method for a water treatment membrane according to the first aspect, wherein in the first cleaning step, after the first cleaning fluid is passed in the forward direction from the primary surface to the secondary surface, at least the primary surface is kept in a state immersed in the first cleaning fluid.

With the cleaning method for a water treatment membrane according to the second aspect, it is possible to supply a fresh first cleaning fluid which contains an appropriate concentration of a metal eluent without containing an eluent from the scale to the primary surface, where the amount of attached scale is large. Further, by maintaining an immersed state, it is possible to deliver the first cleaning fluid to every corner of the water treatment membrane and to sufficiently elute the metal scale attached to the primary and secondary surfaces. As a result, the cleaning efficiency is further enhanced.

A third aspect of the present invention is the cleaning method for a water treatment membrane according to the first or second aspect, wherein in the second cleaning step, after the second cleaning fluid is passed in the reverse direction from the secondary surface to the primary surface, at least the primary surface is kept in a state immersed in the second cleaning fluid.

With the cleaning method for a water treatment membrane according to the third aspect, it is, possible to wash the decomposition products of the organic scale to the primary surface side so as to enable efficient cleaning. Further, by maintaining an immersed state, it is possible to deliver the second cleaning fluid to every corner of the water treatment membrane and to sufficiently elute the organic scale attached to the primary and secondary surfaces. As a result, the cleaning, efficiency is further enhanced.

A fourth aspect of the present invention is the cleaning method for a water treatment membrane according to any one of the first through third aspects, wherein, prior to the first cleaning step, the method further includes a preliminary cleaning step of bringing a third cleaning fluid containing an oxidizer with a lower concentration than that of the second cleaning fluid into contact with at least the primary surface so as to eliminate organic scale attached to the water treatment membrane.

With the cleaning method for a water treatment membrane according to the fourth aspect, the concentration of the oxidizer that is used is low, so a rinsing step is unnecessary prior to transitioning to ordinary operation. That is, it is possible to transition to ordinary operation immediately after the preliminary cleaning step is performed. Thus, it is possible to reduce the rate of attachment of organic scale by frequently performing the preliminary cleaning step as a type of routine maintenance.

A fifth aspect of the present invention is the cleaning method for a water treatment membrane according to the fourth aspect, wherein an operation of performing water treatment using the water treatment membrane and the preliminary cleaning step are alternately repeated at least once.

With the cleaning method for a water treatment membrane according to the fifth aspect, it is possible to transition to the ordinary operation for performing water treatment without a rinsing step after a simple preliminary cleaning step is completed in a short amount of time, which makes it possible to enhance operational efficiency. In addition, by alternately repeating the operation and the preliminary cleaning step, it is possible to extend the amount of time until the amount of attached organic scale reaches an amount that would impede operations, which makes it possible to further enhance operational efficiency After miming for a long period of time, time can be taken to clean organic scale that has attached in large quantities with the first and second cleaning steps.

A sixth aspect of the present invention is the cleaning method for a water treatment membrane according to the fifth aspect, wherein organic scale attached to the water treatment membrane gradually increases each time the operation and the preliminary cleaning step are alternately repeated.

With the cleaning method for a water treatment membrane according to the sixth aspect, when transitioning to the first and second cleaning steps, it is easy to leave behind a small amount of metal scale in the water treatment membrane after the first cleaning step. Using the small amount of remaining metal scale as a catalyst, active oxygen originating from the oxidizer in the second cleaning step is generated by the action of the catalyst, which makes it possible to even further enhance the organic scale cleaning effect.

A seventh aspect of the present invention is the cleaning method for a water treatment membrane according to any one of the first through sixth aspects, wherein the metal eluent is any one or more types selected from the group consisting of citric acid, phosphonic acid, glycolic acid, ethylenediaminetetraacetic acid, formic acid, and oxalic acid.

With the cleaning method for a water treatment membrane according to the seventh aspect, it is easy to eliminate most metal scale while leaving behind a small amount of metal scale in the water treatment membrane. Using the small amount of remaining metal scale as a catalyst, active oxygen originating from the oxidizer is generated by the effect of the catalyst in the second cleaning step, which makes it possible to even further enhance the organic scale cleaning effect.

An eighth aspect of the present invention is the cleaning method for a water treatment membrane according to any one of the first through seventh aspects, wherein the oxidizer contained in the second cleaning fluid is any one or more types selected from the group consisting of hydrogen peroxide, percarbonate, persulfate, hypochlorite, permanganate, chlorine dioxide, and ozone.

With the cleaning method for a water treatment membrane according to the eighth aspect, a small amount of metal scale remaining in the first cleaning step is used as a catalyst, and active oxygen originating from the oxidizer can be generated by the action of the catalyst. As a result, it is possible to even further enhance the organic scale cleaning effect.

A ninth aspect of the present invention is the cleaning method for a water treatment membrane according to any one of the first through eighth aspects, wherein, prior to the first cleaning step, freshwater is passed through the water treatment membrane to eliminate salt attached to the water treatment membrane.

With the cleaning method for a water treatment membrane according to the ninth aspect, it is possible to prevent the reduction of the metal scale eliminating effect of the metal eluent by allowing the metal eluent used in the first cleaning step to precipitate by reacting with the salt.

A tenth aspect of the present invention is the cleaning method for a water treatment membrane according to any one of the first through ninth aspects, wherein, after the first cleaning step, a catalyst solution containing a metal salt functioning as a catalyst for generating active oxygen from the oxidizer contained in the second cleaning fluid is brought into contact with the water treatment membrane.

With the cleaning method for a water treatment membrane according to the tenth aspect, even if nearly all of the metal scale is eliminated in the first cleaning step, a metal component contained in the catalyst solution may be attached to the water treatment membrane, and the metal component may be made to function as a catalyst in the second cleaning step so as to generate active oxygen in the water treatment membrane. As a result, it is possible to even further enhance the organic scale cleaning effect.

### Advantageous Effects of Invention

With the cleaning method for a water treatment membrane according to the present invention, it is possible to suppress the oxidative degradation of the water treatment membrane due to active oxygen originating from an oxidizer, and to achieve a sufficient cleaning effect.

### BRIEF DESCRIPTION OF DRAWINGS

FIG. 1 is a cross-sectional schematic view of a reverse osmotic membrane module in which a reverse osmotic membrane is provided in a vessel.

FIG. 2 is a cross-sectional schematic view of a reverse osmotic membrane illustrating a state in which scale is eliminated stepwise by the cleaning method of a first embodiment of the present invention.

FIG. 3 is a cross-sectional schematic view of a reverse osmotic membrane illustrating a state in which scale is eliminated stepwise by the cleaning method of a second embodiment of the present invention.

### DESCRIPTION OF EMBODIMENTS

The cleaning method of the present invention can be applied to a known water treatment membrane. The types and shapes of water treatment membranes to which the cleaning method of the present invention can be applied are not particularly limited. For example, the membrane may be a flat disc-shaped membrane, a hollow fiber membrane, a spiral membrane, or a tubular membrane. The water treatment membrane preferably has at least two surfaces including a front surface and a back surface, that is, a primary surface (front surface) for inflow of untreated water to be treated and a secondary surface (back surface) for outflow of treated water passing through the water treatment membrane. The type of untreated water to be treated by the water treatment membrane is not particularly limited, and examples thereof include seawater, river water, tap water and wastewater, rain water, and industrial wastewater.

The cleaning method of the present invention exhibits an outstanding effect on a water treatment membrane to which organic scale and metal scale are attached, so the untreated water preferably contains organic substances and metal salts. In addition, since the cleaning method of the present invention can efficiently clean a water treatment membrane installed in a large-scale water treatment device in an online state without eliminating the water treatment membrane to the outside of the device, the method is suitable for the cleaning of a reverse osmotic membrane (RO membrane) installed in a seawater desalination plant, for example.

The constituent material of the water treatment membrane to which the cleaning method of the present invention is applied is not particularly limited, and examples thereof include polyolefin, polysulfone, polyacrylonitrile, polyester, polycarbonate, polyamide, polyvinyl chloride, polyvinyl alcohol, polyvinylidene chloride, polyvinyl fluoride, polyvinylidene chloride, hexafluoropropylene, chlorotrifluoroethylene, tetrafluoroethylene, cellulose acetate, silicone polymers, and ceramics.

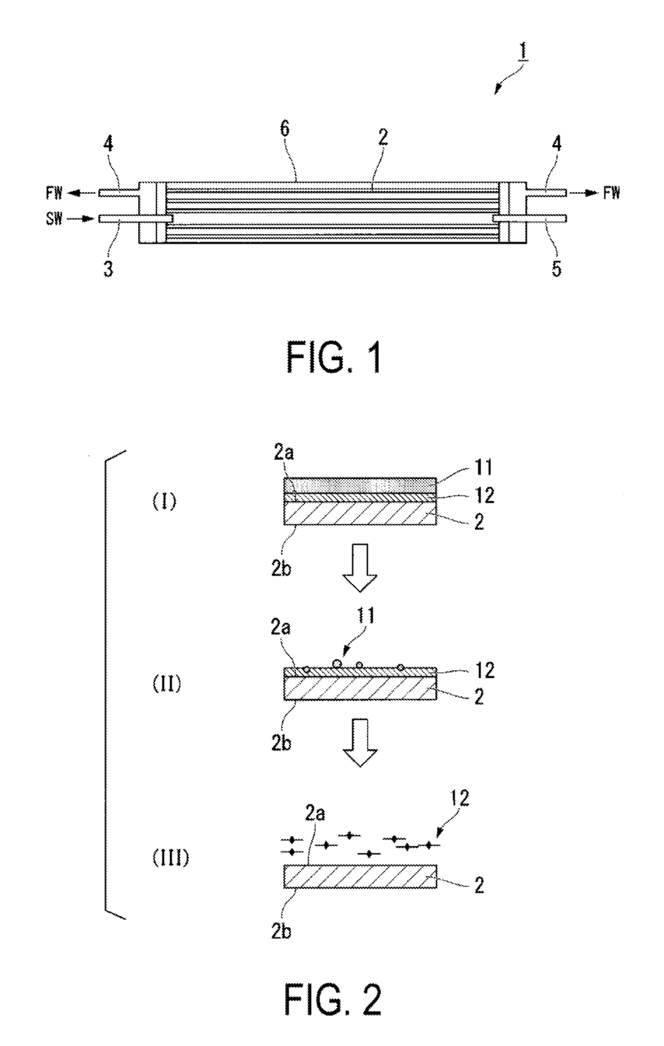

An example of a water treatment membrane to which the cleaning method of the present invention can be applied is an RO membrane module 1 illustrated in FIG. 1. In the RO membrane module 1 illustrated in FIG. 1, a plurality of hollow fiber RO membranes 2 (also simply called “hollow fiber membranes 2” hereafter) are folded back in a U-shape, fixed with a resin while maintaining a state in which the end of each hollow fiber membrane 2 is open, and further housed in a vessel (pressure-resistant container) 6.

Seawater SW is fed into the vessel 6 from a feeder line 3 and brought into contact and passed through a primary surface constituting the outer periphery of the hollow fiber membranes 2. Desalinated permeated water FW is accumulated at both ends of each hollow fiber membrane 2 from a secondary surface constituting the inner periphery of the hollow fiber membrane 2 and is collected from a permeated water outlet line 4. Concentrated water that has not passed into each hollow fiber membrane 2 is discharged from a brine outlet line 5 to the outside of the vessel 6.

Embodiments of the cleaning method of the present invention will be described hereinafter using a case in which an RO membrane 2 provided in the RO membrane module 1 of FIG. 1 is used as an example.

As illustrated in FIG. 2(D, metal scale 11 containing metal ions contained in the seawater and organic scale 12 containing organic matter are attached to a primary surface 2a of an RO membrane 2 after a desalination operation (run) has been performed.

In the drawing, each scale is depicted in two separate layers for convenience, but in actuality, both scales are attached in a mixed state. In addition, there are also cases in which the same scale is attached not only to the primary surface 2a, but also to the inside and a secondary surface 2b of the RO membrane 2, but such cases are not illustrated. Ordinarily the amount of scale attached to the primary surface 2a is greater than the amount of scale attached to the inside and the secondary surface 2b of the RO membrane 2.

### First Embodiment

In the cleaning method of a first embodiment for cleaning an RO membrane 2 provided with a primary surface 2a for inflow of untreated water and a secondary surface 2b for outflow of permeated water, a first cleaning step and a second cleaning step are performed in this order. There may be other steps between the first and second cleaning steps, and there may be other steps before the first cleaning, step or after the second cleaning step.

The first cleaning step is a step in which a first cleaning fluid containing a metal eluent is brought into contact with at least the primary surface 2a so as to eliminate the metal scale 11 attached to the RO membrane 2. The first cleaning fluid preferably also comes into contact with the inside and the secondary surface 2b of the RO membrane 2.

The second cleaning step is a step in which a second cleaning fluid containing an oxidizer is brought into contact with at least the primary surface 2a so as to eliminate the organic scale 12 attached to the RO membrane 2. The second cleaning fluid preferably also comes into contact with the inside and the secondary surface 2b of the RO membrane 2.

In this embodiment, it is important for the organic scale 12 to be eliminated using an oxidizer after the metal scale 11 is first eliminated. If an oxidizer were to be brought into contact with the RO membrane 2 in a state with a large amount of residual metal scale 11, a large amount of active oxygen (called active oxygen as a term including oxygen-based radicals) may be generated from the oxidizer since the metal scale 11 functions as a catalyst. When a large amount of active oxygen is generated on the surface and inside of the RO membrane 2, a problem arises in which the oxidative degradation of the RO membrane 2 occurs. In this embodiment, the metal scale 11 is eliminated in advance, which makes it possible to prevent active oxygen originating from the oxidizer from oxidatively degrading the RO membrane 2 and to sufficiently eliminate both the metal scale 11 and the organic scale 12.

### Procedure of the First Cleaning Step

The procedure of this embodiment is such that concentrated water is first discharged from the brine outlet line 5, and after the first cleaning fluid is passed in the forward direction (in the filtering direction) from the primary surface 2a of the RO membrane 2 to the secondary surface 2b of the RO membrane 2, at least the primary surface 2a is kept in a state of being immersed in the first cleaning fluid.

By passing the first cleaning fluid through in the forward direction, it is possible to supply a fresh first cleaning fluid which contains an appropriate concentration of a metal eluent without containing an eluent from the scale to the primary surface 2a, where the amount of attached scale 11 and 12 is large.

The first cleaning fluid may also be allowed to pass through in the reverse direction, but the metal eluent may be consumed on the secondary surface 2b side or may be trapped in the secondary surface 2b without being able to pass through the RO membrane 2. This may prevent the supply of a sufficient amount of the metal eluent to the primary surface 2a and may diminish the cleaning efficiency in comparison to the case of the forward direction. When, the first cleaning fluid is passed through in the reverse direction, a metal eluent capable of passing through the RO membrane 2 is used.

After the first cleaning fluid is allowed to pass through, the first cleaning fluid is kept in a state in which the space on the primary surface 2a side inside the vessel 6 is filled with the first cleaning fluid. This makes it possible to maintain a state in which at least the primary surface 2a is immersed in the first cleaning fluid. By increasing the pressure slightly in this state, some of the first cleaning fluid penetrates into the RO membrane 2 and leaks to the secondary surface 2b. As a result of this pressurization, the inside and the secondary surface 2b of the RO membrane 2 may also be immersed at the same time as the primary surface 2a. Alternatively, the space inside the membrane on the side where water has accumulated may be filled by injecting the first cleaning fluid into the vessel 6 from the permeated water outlet line 4 so as to maintain a state in which the secondary surface 2b of the RO membrane 2 is immersed in the first cleaning fluid.

The method for maintaining a state in which the RO membrane 2 is immersed in the first cleaning fluid is not particularly limited. For example, the first cleaning fluid may be fed from the feeder line 3 to till the space on the primary surface 2a side inside the vessel 6, and the circulation of the first cleaning fluid may be stopped by then stopping feeding and sealing the vessel 6. Alternatively, the first cleaning fluid may be continued to be fed even after the space on the primary surface 2a side inside the vessel 6 is filled with the first cleaning fluid, and the first cleaning, fluid may be discharged from the brine outlet line 5 in the same amount as the fed amount so as to maintain a state in which the RO membrane 2 is immersed in the first cleaning fluid while the first cleaning fluid is circulated.

By maintaining a state in which at least one, and preferably both, of the primary surface 2a and the secondary surface 2b are immersed in the first cleaning fluid, it is possible to sufficiently elute the metal scale 11 attached to the primary surface 2a and the secondary surface 2b and to thereby her enhance the elimination efficiency thereof.

The amount of time that the surfaces are kept in the immersed state is not particularly limited and may for example, be set to less than 24 hours and preferably from around 1 to 6 hours. In addition, a standard for ending cleaning may be set by measuring the turbidity, the concentration of the elated metal scale 11, or the like of the first cleaning fluid used for cleaning with a known method.

After being held for a prescribed amount of time, the eluted metal scale 11 is discharged from the brine outlet line 5 or the like to the outside of the vessel 6 together with the first cleaning fluid. A small amount of the metal scale 11 remains on the primary surface 2a even after the first cleaning step, but this is ordinarily in a permissible amount (FIG. 2(11)). In the event that an impermissibly large amount of metal scale 11 remains, it may be cleaned off to a permissible amount by repeating the first cleaning step two or more times.

In this embodiment, the small amount of residual metal scale 11 is used as a catalyst in the second cleaning step, which enhances the cleaning, efficiency for the organic scale 12.

### Metal Eluent

The metal eluent contained in the first cleaning fluid is not particularly limited as long as it is a chemical capable of eluting metal ions contained in the water to be treated (for example, seawater), such as iron, manganese, magnesium, and calcium constituting the metal scale 11. The metal eluent is preferably a chemical which does not run the risk of oxidatively degrading the RO membrane 2, inhibiting the operation of the RO membrane module 1 after cleaning, or clogging the RO membrane 2 by transforming the organic scale 12.

Examples of suitable metal eluents include citric acid, phosphonic acid, glycolic acid, ethylenediaminetetraacetic acid, formic acid, and oxalic acid. The first cleaning fluid preferably contains at least one type of a chemical selected from the group consisting of the plurality of chemicals listed here.

One possible mechanism that allows these chemicals to elute the metal scale 11 is that metal ions and the chemicals form a chelate bond so as to dissolve in the first cleaning fluid.

The concentration of the metal eluent contained in the first cleaning fluid is not particularly limited and may be set appropriately in accordance with the type of the metal eluent that is used. The concentration range of the suitable metal clients listed above is preferably from 0.5 to 20 mass % and more preferably from 2 to 3 mass %. Here, the total mass of the first cleaning fluid is 100 mass %.

When there is a possibility that the metal eluent that is used may react with salts contained in the seawater to produce a precipitate, the salts attached to the RO membrane 2 are preferably eliminated in advance by passing freshwater through the RO membrane 2 prior to the first cleaning step. When the first cleaning fluid contains phosphoric acid, for example, precipitation occurs as a result of the phosphoric acid reacting with calcium or magnesium in the seawater, so these salts are preferably eliminated in advance. Here, the salts are not components that are attached to the RO membrane 2 and are therefore differentiated from the metal scale.

The direction in which freshwater passes may be the forward direction (from the primary surface 2a toward the secondary surface 2b) or the reverse direction (from the secondary surface 2b toward the primary surface 2a). It is preferable for salts to not be attached to the line for feeding freshwater, so freshwater is preferably fed to the RO membrane 2 from the permeated water outlet line 4. When freshwater is fed to the RO membrane 2 from the permeated water outlet line 4, the freshwater is inevitably passed in the reverse direction. When passing freshwater in the reverse direction, the cleaning efficiency can be further enhanced by performing so-called flushing cleaning, whereby air is passed together with the freshwater.

In addition, by allowing air to pass through, the first cleaning fluid to be fed next can reach every corner inside the water treatment membrane once the flushing water is sufficiently discharged from inside the membrane, which makes it possible to further enhance the cleaning efficiency.

### Procedure of the Second Cleaning Step

Next, a second cleaning fluid containing an oxidizer is injected into the secondary surface 2b side of the RO membrane 2 inside the vessel 6 from the permeated water outlet line 4, and the second cleaning fluid containing the oxidizer is passed through in the reverse direction from the secondary surface 2b of the RO membrane 2 to the primary surface 2a of the RO membrane 2. At least the primary surface 2a is then kept in a state in which it is immersed in the second cleaning fluid.

By allowing the second cleaning fluid to pass through in the reverse direction, it is possible to wash away the decomposition products of the organic scale 12 to the primary surface 2a side so as to enable efficient cleaning. When the second cleaning fluid is passed through in the reverse direction, an oxidizer capable of passing through the RO membrane 2, such as hydrogen peroxide or chlorine monoxide is used.

The second cleaning fluid may also be allowed to pass through in the forward direction. However, the decomposition products described above contain polymers originating from microorganisms. For this reason, when the second cleaning fluid is fed in the forward direction in the initial stages of the second cleaning step, the RO membrane 2 may be clogged by the decomposition products or the cleaning efficiency may be diminished in comparison to the case of the reverse direction.

After the second cleaning fluid is allowed to pass through, the second cleaning fluid is kept in a state in which the inside of the vessel 6 on the primary surface 2a side is filled with the second cleaning fluid, which makes it possible to maintain a state in Which at least the primary surface 2a is immersed in the second cleaning fluid. By applying the pressure somewhat in the forward direction in this state, some of the second cleaning fluid penetrates into the RO membrane 2 and leaks to the secondary surface 2b. As a result, the inside and the secondary surface 2b of the RO membrane 2 may also be immersed at the same time as the primary surface 2a. Alternatively the space inside the membrane on the side where water has accumulated may be filled by injecting the second cleaning fluid from the permeated water outlet line 4 so as to maintain a state in which the secondary surface 2b of the RO membrane 2 is immersed in the second cleaning fluid.

The method for maintaining a state in which the RO membrane 2 is immersed in the second cleaning fluid is not particularly limited. For example, the second cleaning fluid may be fed from the feeder line 3 to fill the space on the primary surface 2a side inside the vessel 6, and the circulation of the second cleaning fluid may be stopped by then stopping feeding and sealing the vessel 6. Alternatively, the second cleaning fluid may be continued to be fed even after the space on the primary surface 2a side inside the vessel 6 is filled with the second cleaning fluid, and the second cleaning fluid may be discharged from the brine outlet line S in the same amount as the fed amount so as to maintain a state in which the RO membrane 2 is immersed in the second cleaning fluid while the second cleaning fluid is circulated.

By maintaining a state in which at least one, and preferably both, of the primary surface 2a and the secondary surface 2b are immersed in the second cleaning fluid, it is possible to sufficiently elute the organic scale 12 attached to the primary surface 2a and the secondary surface 2b and to thereby further enhance the elimination efficiency thereof.

The amount of time that the surfaces are kept in the immersed state is not particularly limited and may, for example, be set to less than 24 hours and preferably from around 1 to 5 hours. In addition, a standard for ending cleaning may be set by measuring the turbidity, the concentration of the eluted or decomposed organic scale 12, the TOC (Total Organic Carbon), the COD (Chemical Oxygen Demand), or the like of the second cleaning fluid used for cleaning with a known method.

After being held for a prescribed amount of time, the eluted organic scale 12 is discharged from the brine outlet line 5 or the like to the outside of the vessel 6 together with the second cleaning fluid so as to obtain an RO membrane 2 in which. the metal scale 11 and organic scale 12 have been cleaned off (FIG. 2(III)). In the event that the organic scale 12 remains, further cleaning may be performed by repeating the second cleaning step a plurality of times.

### Oxidizer

The oxidizer contained in the second cleaning fluid may be an oxidizer which generates active oxygen when it comes into contact with a metal, or an oxidizer which does not generate active oxygen even when it comes into contact with a metal. The oxidizer is not particularly limited as long as it is a chemical capable of oxidatively decomposing the organic scale 12.

From the perspective of enhancing cleaning efficiency, the metal scale 11 remaining in the RO membrane 2 is preferably used as a catalyst, and an oxidizer which generates active oxygen in the RO membrane 2 is preferably used. Because active oxygen oxidatively decomposes the organic scale 12 with high potency, it is possible to enhance the cleaning efficiency in comparison to cases in which active oxygen is not used. Here, in the event that an excessive amount of active oxygen is generated, the RO membrane 2 may be oxidatively degraded. However, since the metal scale 11 is eliminated in advance in this embodiment, the remaining metal component functioning as a catalyst is minimal, and the generation of active oxygen in an amount great enough to cause the oxidative degradation of the RO membrane 2 is prevented.

Examples of the oxidizer described above include hydrogen peroxide, percarbonate, persulfate, hypochlorite, permanganate, chlorine dioxide, chlorine monoxide, and ozone. Here, the cations constituting each salt are not particularly limited, and examples thereof include inorganic cations such as sodium, potassium, lithium, calcium, magnesium, beryllium, and ammonium. More specific examples of salts that are preferable as oxidizers include sodium percarbonate, sodium persulfate, ammonium persulfate, sodium hypochlorite, and potassium permanganate. The second cleaning fluid preferably contains at least one type of an oxidizer selected from the group consisting of the plurality of oxidizers listed here.

Of these, hydrogen peroxide, percarbonate, persulfate, and ozone, which generate active oxygen without generating chlorine, are preferable, and percarbonate and hydrogen peroxide, which generate OH radicals having a potent oxidizing power, are even more preferable.

The concentration of the oxidizer contained in the second cleaning fluid is not particularly limited and may be set appropriately in accordance with the type of the oxidizer that is used. The concentration range of the suitable metal oxidizers listed above is preferably from 0.5 to 10 mass % and more preferably from 2 to 3 mass %. Here, the total mass of the second cleaning fluid is 100 mass %.

### Feeding the Catalyst

When nearly all of the metal scale 11 is eliminated in the first cleaning step, the amount of active oxygen generated in the RO membrane 2 in the second cleaning step may be so small that the decomposition of the organic scale 12 due to active oxygen does not sufficiently occur. When this problem is foreseen, a catalyst solution containing a metal salt functioning as a catalyst is preferably brought into contact with the RO membrane 2 after the first cleaning step. An appropriate amount of a metal salt or metal ion as a catalyst attaches to the RO membrane 2 in contact with the catalyst solution. As a result, active oxygen is sufficiently generated from the oxidizer contained in the second cleaning fluid, and the elimination efficiency of the organic scale 12 is thereby enhanced.

When a first cleaning fluid containing phosphonic acid is used in the first cleaning step, there is a high probability that most of the metal scale 11 has been eliminated and that no metal components capable of functioning as a catalyst remain in the RO membrane 2. The reason for this is that phosphonic acid has a particularly potent effect of eliminating the metal scale 11.

The method for bringing the catalyst solution into contact with the RO membrane 2 is not particularly limited, and an example thereof includes the same method as the method used to bring the first or second cleaning fluid into contact with the RO membrane 2. The catalyst solution may he fed alone to the RO membrane 2 before the second cleaning fluid is fed to the RO membrane 2, or a mixed solution prepared by mixing the second cleaning fluid and the catalyst solution may be fed to the RO membrane 2. However, the generation of active oxygen is initiated at the point when the mixed solution is prepared and before it reaches the RO membrane 2. Therefore, it is preferable to first bring the catalyst solution alone into contact with the RO membrane 2 and to provide an appropriate amount of a catalyst metal to the RO membrane 2 in advance in that the amount, location, and timing of the generation of active oxygen are easily controlled.

The catalyst contained in the catalyst solution has a function of generating active oxygen as a result of coming into contact with the oxidizer contained in the second cleaning fluid. The type of the metal salt functioning as the catalyst may be selected appropriately in accordance with the type of the oxidizer. Examples thereof include known metal salts including transition metals such as iron and manganese. More specific examples of preferable metal salts include iron chloride and manganese chloride.

The concentration of the metal salt functioning as the catalyst in the catalyst solution is not particularly limited and may be set, for example to 1 to 10 mass %. Here, the total mass of the catalyst solution is 100 mass %.

The amount of time that the catalyst solution and the RO membrane 2 are in contact with one another is not particularly limited and may be set to around 1 to 60 minutes as long as the concentration of the metal salt is within the range described above.

### Rinsing Step

With the objective of preventing the oxidizer and the metal eluent from remaining in the RO membrane 2, a rinsing step of rinsing the RO membrane 2 is preferably performed with a rinsing fluid such as seawater or freshwater not containing an oxidizer after the second cleaning step.

The method of rinsing the RO membrane 2 is not particularly limited, and examples thereof include a method of feeding seawater from the feeder line 3 so as to. come into contact with the primary surface 2a of the RO membrane 2 and maintaining a state in which the RO membrane 2 is immersed in the seawater while continuously discharging the seawater from the brine outlet line 5, and a method of flushing (reverse cleaning) the RO membrane 2 by injecting freshwater from the permeated water outlet line 4 in the reverse direction.

The amounts of the oxidizer and the metal eluent contained in the discharged rinsing fluid can be measured with known methods so as to assess Whether to end the rinsing step. After the rinsing step is complete, normal operation is performed.

### Second Embodiment

Prior to the first step in the first embodiment described above a preliminary washing step may be performed wherein a third cleaning fluid containing an oxidizer with a lower concentration than that of the second cleaning fluid is brought into contact with at least the primary surface 2a of the RO membrane 2 so as to eliminate the organic scale 12 attached to the RO membrane 2.

The detergency of the third cleaning fluid is weaker than that of the second cleaning fluid, so the organic scale 12 is not completely eliminated. However, since the oxidizer concentration is comparatively low, a rinsing step is unnecessary prior to transitioning to the normal operation for desalinating seawater. Thus, the amount of time that the normal operation is stopped to perform the preliminary cleaning step is short, and the process from the beginning to the end of the preliminary cleaning, step is completed in 0.1 to 2 hours, for example.

The type of the oxidizer contained in the third cleaning fluid is not particularly limited, and, for example, one or more types of the oxidizers listed as oxidizers that may be contained in the second cleaning fluid may be applied. Specifically, sodium percarbonate and hydrogen peroxide, for example, are preferably mixed at a molar ratio of 2:3 and used as the oxidizer of the third cleaning fluid.

The type of the oxidizer contained in the third cleaning fluid may be the same as or different than the type of the oxidizer contained in the second cleaning fluid.

The concentration of the oxidizer contained in the third cleaning fluid is preferably low enough for the rinsing step to be unnecessary and is preferably from 1 ppm to 100 ppm and more preferably from 5 to 10 ppm. When within this preferable range, the elimination of the organic scale 12 can be executed smoothly, so there is no risk that the decomposition products of the organic scale 12 will cause the clogging of the RO membrane 2, and the rinsing step is also unnecessary

The method for bringing the third cleaning fluid into contact with the RO membrane 2 is not particularly limited and may be the same as the method used to bring the first or second cleaning fluid into contact with the RO membrane 2. However, from the perspective of ending the preliminary cleaning step in a short amount of time, it is preferable to use a method of mixing the oxidizer in the seawater to be fed from the feeder line 3 to prepare a third cleaning fluid containing seawater, feeding the third cleaning fluid from the feeder line 3 in the same manner as in the normal operation, and bringing the third cleaning fluid into contact with the RO membrane 2.

In the second embodiment, it is preferable to alternatively repeat the normal operation and the preliminary cleaning step one or more times prior to transitioning from the preliminary cleaning step to the first cleaning step. That is, it is preferable. to frequently perform simple cleaning with the preliminary cleaning step as a form of routine maintenance.

Specifically, a cycle of performing normal operation for 8 hours, ending the preliminary cleaning step in 1 hour, and once again performing normal operation for 8 hours may be repeated a plurality of times, for example. That is, this is a cycle of feeding the third cleaning fluid to the RO membrane 2 from the feeder line 3 intermittently (for example, every 8 hours).

By repeating the preliminary cleaning step, it is possible to reduce the rate of increase of the amount of the organic scale 12 attached to the RO membrane 2. Such reduction makes it possible to reduce the frequency with which the first and second cleaning steps are performed. For example, when the preliminary cleaning step is performed every 8 hours, the frequency with which the first and second cleaning steps are performed can be set to about 1 time per 1 to 3 months.

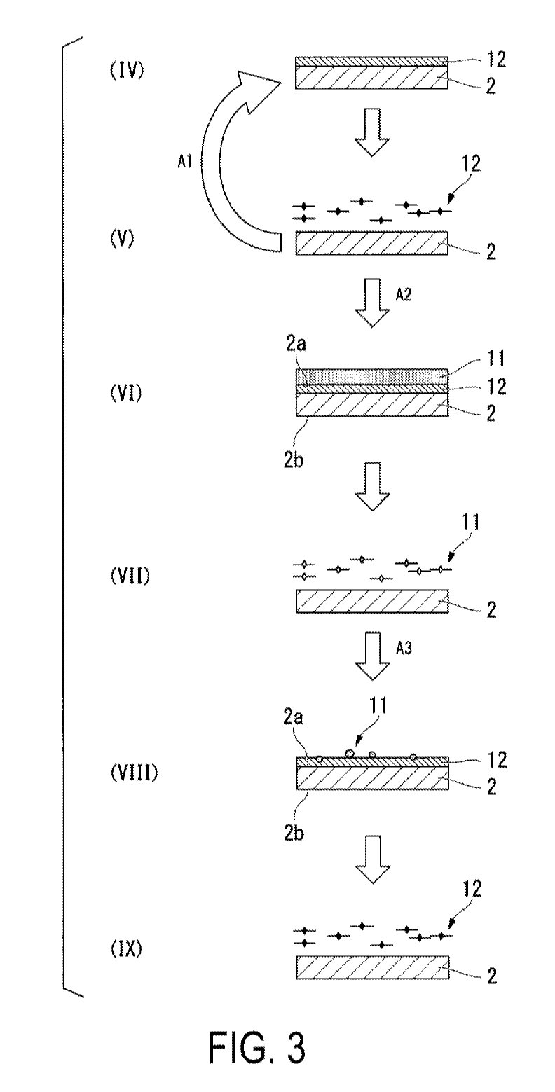

As illustrated in FIG. 3, when ordinary operation and the preliminary cleaning step are alternately repeated (FIGS. 3(IV) and (V), A1), the organic scale 12 is cleaned, and the rate at which the organic scale is attached, which is originally comparatively high, is reduced (FIG. 3(V)), while the rate at which the metal scale 11 is attached is reduced negligibly. As a result, the metal scale 11 is attached gradually so that a considerable amount of metal scale is accumulated (FIG. 3(VI), A2). If the second cleaning step were to be performed without the first cleaning step being performed (skipped) in a state in which a large amount of the metal scale 11 has accumulated in the RO membrane 2, a large amount of active oxygen would be generated at once in the RO membrane 2, causing the oxidative degradation or clogging of the RO membrane 2. However, in this embodiment, the first cleaning step (FIG. 3(VII), A3) and the second cleaning step (FIGS. 3(VIII) and (IX)) are performed in this order in the same manner as in the first embodiment described above after the preliminary cleaning step, so there is no concern regarding the generation of a large amount of active oxygen. That is, when the preliminary cleaning step is performed, the significance of performing the first cleaning step prior to the second cleaning step is enhanced substantially.

As described above, after metal scale has accumulated in the water treatment membrane each time the preliminary cleaning step is performed, the process transitions to the first cleaning step so as to eliminate most of the metal scale with the metal eluent of the first cleaning fluid, which makes it easy to allow an appropriately small amount of metal scale to remain as a catalyst in the water treatment membrane. Using the metal scale remaining in the water treatment membrane as a catalyst in the following second step, active oxygen originating from the oxidizer of the second cleaning fluid is generated by the action of the catalyst, which makes it possible to even further enhance the organic scale cleaning effect.

Known chemicals such as surfactants or pH adjusters for promoting cleaning may he added to the first cleaning fluid, the second cleaning fluid the third cleaning fluid, and the catalyst solution described above as necessary.

Embodiments of the cleaning method for a water treatment membrane according to the present invention were described above, but the present invention is not limited to the aforementioned embodiments and may be changed as appropriate in a range that does not deviate from the main intent of the present invention, or the components of the embodiments described above may be replaced with known components as necessary.

### EXAMPLES

Next, the present invention will be described in further detail using examples, but the present invention is not limited by these examples.

### Example 1

The RO membrane module 1 illustrated in FIG. 1, which was provided in a test plant for desalinating seawater, was cleaned as follows.

First, after seawater was discharged from the brine outlet line 5, a first cleaning fluid containing citric acid with a concentration of from 0.5 to 20 wt. % as a cleaning agent (metal eluent) was fed from the feeder line 3 with a flow in the same forward direction as the filtration direction, and the space on the primary surface 2a side of the RO membrane 2 inside the vessel 6 was filled. At this time, a fresh first cleaning fluid was allowed to pass through the inlet part of the vessel 5, where there was a large amount of scale attachment. After it was confirmed that the vessel 6 was full, immersion cleaning, was performed for less than 24 hours or from 1 to 6 hours (first cleaning step). After immersion cleaning, the first cleaning fluid was discharged to the outside of the vessel.

Next, reverse cleaning was performed, wherein a second cleaning fluid containing hydrogen peroxide (oxidizer) at a concentration of from 1 to 10 wt. % was injected from the permeated water outlet line 4 with a flow in the opposite direction to the filtration direction, and this was allowed to pass through the RO membrane 2. After the space on the primary surface 2a side of the RO it 2 inside the vessel 6 was filled and it was confirmed that the vessel 6 was fill, immersion cleaning was performed for a certain amount of time (second cleaning step). After immersion cleaning, the second cleaning fluid was discharged to the outside of the vessel.

As a result of performing the cleaning method described above, metal scale and organic scale that had attached to the RO membrane 2 provided in the test plant were sufficiently eliminated. In addition, in the second cleaning step, there was no generation it active oxygen that would cause the oxidative degradation of the RO membrane 2, and active oxygen was generated gradually by the catalytic action of the small amount of metal scale remaining on the surface of the RO membrane 2, which yielded a sufficient cleaning effect. The amount of active oxygen that was generated was assessed by the amount of air bubbles of oxygen gas generated secondarily.

### Comparative Example 1

The RO membrane module 1 was cleaned in the same manner as in Example 1 with the exception that the second cleaning step was performed first and the first cleaning step was performed thereafter. As a result, in the second cleaning step that was performed first, a comparatively large amount of air bubbles were observed on the surface of the RO membrane 2, so it was assessed that the generation of a relatively large amount of active oxygen occurred to an extent that would cause concern regarding the oxidative degradation of the RO membrane 2. In addition, the cleaning effect was inferior to that of Example 1.

### Example 2

The RO membrane module 1 illustrated in FIG. 1, which was provided in a test plant for desalinating seawater, was cleaned as follows.

First, after seawater was discharged from the brine outlet line 5, freshwater was injected from the permeated water outlet line 4 with a flow in the opposite direction to the filtration direction, and the freshwater was allowed to pass through the RO membrane 2 to perform flushing reverse cleaning. Air was then blown in so as to discharge the flushing water from the inside of the RO membrane 2 as much as possible, which created gaps in the RO membrane 2 to allow the next first cleaning fluid to penetrate easily.

Next, a first cleaning fluid which contained phosphonic acid with a concentration of from 0.5 to 20 wt. % as a cleaning agent (metal eluent) and had a pH level adjusted to 5 to 6 was fed from the feeder line 3 with a flow in the same forward direction as the filtration direction, and gaps inside the RO membrane 2 and the space on the primary surface 2a side of the RO membrane 2 inside the vessel 6 were filled.

At this time, a fresh first cleaning fluid was allowed to pass through the inlet part of the vessel 6 where there was a large amount of scale attachment. After it was confirmed that the vessel 6 was full, immersion cleaning was preformed for less than 24 hours or from 1 to 6 hours (first cycle of the first cleaning step). After immersion cleaning, the first cleaning fluid was discharged to the outside of the vessel. The first cleaning fluid was then fed once again, and the same immersion cleaning and discharge processes were performed (second cycle of the first cleaning step).

Next, freshwater in which iron chloride with a concentration of from 10 to 30 wt. % was dissolved (catalyst solution) was fed in the forward direction from the feeder line 3 and brought into contact with the primary surface 2a of the RO membrane 2 inside the vessel 6, and the catalyst solution was discharged to the outside of the vessel in a state in which iron ions remained on the RO membrane 2.

Next, a second cleaning fluid containing sodium percarbonate (oxidizer) at a concentration of from 1 to 50 wt. % was charged from the feeder line 3 with a flow in the same forward direction as the filtration direction, and after the space on the primary surface 2a side of the RO membrane 2 inside the vessel 6 was filled and it was confirmed that the vessel 6 was full, immersion cleaning was performed for a certain amount of time (second cleaning step). After immersion cleaning, the second cleaning fluid was discharged to the outside of the vessel.

As a result of the cleaning method described above, metal scale and organic scale that had attached to the RO membrane 2 provided in the test plant were sufficiently eliminated. In addition, in the second cleaning step, active oxygen was generated gradually by the catalytic action of the small amount of iron ions remaining on the surface of the RO membrane 2, which yielded a sufficient cleaning effect.

### INDUSTRIAL APPLICABILITY

The present invention can be applied extensively in the field of water treatment membranes.

While the above has described embodiments of the present invention in detail with reference to the drawings, each configuration of each embodiment and the combinations thereof are merely examples, and additions, omissions, substitutions, and other changes may be made without deviating from the spirit and scope of the present invention. The present invention is not to be considered as being limited by the foregoing description but is only limited by the scope of the appended claims.

### REFERENCE SIGNS LIST

1 RO membrane module
2 RO membrane
2a Primary surface of RO membrane
2b Secondary surface of RO membrane
3 Feeder line
4 Permeated water outlet line
5 Brine outlet line
6 Vessel
11 Metal scale
12 Organic scale

1-10. (canceled)

11. A cleaning method for a water treatment membrane provided with a primary surface for inflow of untreated water and a secondary surface for outflow of treated water, the method comprising:
a first cleaning step of bringing a first cleaning fluid containing phosphonic acid as a metal eluent into contact with at least the primary surface and eliminating metallic scale attached to the water treatment membrane; and
a second cleaning step of bringing a second cleaning fluid containing an oxidizing agent into contact with at least the primary surface and eliminating organic scale attached to the water treatment membrane,

12. The cleaning method for a water treatment membrane according to claim 11, wherein in the first cleaning step, after the first cleaning fluid is passed in the forward direction from the primary surface to the secondary surface, at least the primary surface is kept in a state immersed in the first cleaning fluid.

13. The cleaning method for a water treatment membrane according to claim 11, wherein in the second cleaning step, after the second cleaning fluid is passed in the reversed direction from the secondary surface to the primary surface, at least the primary surface is kept in a state immersed in the second cleaning fluid.

14. The cleaning method for a water treatment membrane according to claim 11, wherein, prior to the first cleaning step, the method further including a preliminary cleaning step of bringing a third cleaning fluid containing an oxidizer with a lower concentration than that of the second cleaning fluid into contact with at least the primary surface so as to eliminate organic scale attached to the water treatment membrane.

15. The cleaning method for a water treatment membrane according to claim 14, wherein an operation of performing water treatment using the water treatment membrane and the preliminary cleaning step are alternately repeated at least once.

16. The cleaning method for a water treatment membrane according to claim 15, wherein organic scale attached to the water treatment membrane gradually increases each time the operation and the preliminary cleaning step are alternately repeated.

17. The cleaning method for a water treatment membrane according to claim 11, wherein any one or more types selected from the group consisting of citric acid, glycolic acid, ethylenediaminetetraacetic acid, formic acid, and oxalic acid are further contained as the metal eluent.

18. The cleaning method for a water treatment membrane according to claim 11, wherein the oxidizer contained in the second cleaning fluid is any one or more types selected from the group consisting of hydrogen peroxide, percarbonate, persulfate, hypochlorite, permanganate, chlorine dioxide, and ozone.

19. The cleaning method for a water treatment membrane according to claim 11, wherein, prior to the first cleaning step, freshwater is passed through the water treatment membrane to eliminate salt attached to the water treatment membrane.

20. The cleaning method for a water treatment membrane according to claim 11, wherein, after the first cleaning step, a catalyst solution containing a metal salt functioning as a catalyst for generating active oxygen from the oxidizer contained in the second cleaning fluid is brought into contact with the water treatment membrane.
